(19) United States
(12) Patent Application Publication
(10) Pub. No.: US 2023/0361791 A1
(43) Pub. Date: Nov. 9, 2023

(54) RECONFIGURABLE WIRELESS RECEIVER USING FILTERS WITH DIFFERENT FILTER ARCHITECTURE, OSCILLATORS WITH DIFFERENT OSCILLATOR ARCHTECTURE, AND/OR TIME-SHARING PHASE-LOCKED LOOP CORE

(71) Applicant: Airoha Technology Corp., Hsinchu City (TW)

(72) Inventors: Yu-Hua Liu, Hsinchu County (TW); Shu-Yu Lin, New Taipei City (TW)

(73) Assignee: Airoha Technology Corp., Hsinchu City (TW)

(21) Appl. No.: 17/737,046

(22) Filed: May 5, 2022

(51) Int. Cl. H04B 1/00; H04B 1/40; H04K 3/00

(52) U.S. Cl. CPC H04B 1/0057; H04B 1/40; H04K 3/22

(57) ABSTRACT

A sub-circuit of a reconfigurable wireless receiver includes a down-conversion circuit and a plurality of filters. The down-conversion circuit applies down-conversion to a first signal, and generates and outputs a plurality of second signals each derived from down-converting the first signal. The filters are coupled to the down-conversion circuit, and apply filtering to the second signals for generating a plurality of filter outputs, respectively, wherein the filters includes a first filter and a second filter, and the first filter and the second filter have different filter architecture.

### BACKGROUND OF THE INVENTION

### 1. Field of the Invention

The present invention relates to wireless communications, and more particularly, to a reconfigurable wireless receiver using filters with different filter architecture, oscillators with different oscillator architecture, and/or a time-sharing phase-locked loop (PLL) core.

### 2. Description of the Prior Art

In many wireless communication systems, a radio-frequency (RF) signal may be down-converted to an intermediate-frequency (IF) signal or baseband signal prior to conversion to a digital signal for further digital processing. Filters are conventionally used to remove interference noise from the IF or baseband signal in order to decrease the signal's dynamic range which may be helpful in the subsequent conversion from an analog signal to a digital signal. A filter implemented using high performance filter architecture can achieve good interference rejection at the expense of high current consumption. When a wireless receiver is employed by a portable device powered by a battery device, the wireless receiver with high power consumption makes the portable device have shorter operation time. Thus, there is a need for an innovative wireless receiver structure with low power consumption and high receiver performance.

### SUMMARY OF THE INVENTION

One of the objectives of the claimed invention is to provide a reconfigurable wireless receiver using filters with different filter architecture, oscillators with different oscillator architecture, and/or a time-sharing phase-locked loop (PLL) core.

According to a first aspect of the present invention, an exemplary sub-circuit of a reconfigurable wireless receiver is disclosed. The exemplary sub-circuit of the reconfigurable wireless receiver includes a down-conversion circuit and a plurality of filters. The down-conversion circuit is arranged to apply down-conversion to a first signal, and generate and output a plurality of second signals each derived from down-converting the first signal. The filters are coupled to the down-conversion circuit, and arranged to apply filtering to the second signals for generating a plurality of filter outputs, respectively, wherein the filters include a first filter and a second filter, and the first filter and the second filter have different filter architecture.

According to a second aspect of the present invention, an exemplary sub-circuit of a reconfigurable wireless receiver is disclosed. The exemplary sub-circuit of the reconfigurable wireless receiver includes a down-conversion circuit. The down-conversion circuit is arranged to apply down-conversion to a first signal, and generate and output a plurality of second signals each derived from down-converting the first signal. The down-conversion circuit includes a local oscillator (LO) signal generation circuit and a plurality of mixers. The LO signal generation circuit includes a plurality of signal paths, a phase-locked loop (PLL) core circuit, and a plurality of mixers. A plurality of oscillators are located at the signal paths, respectively. The oscillators are arranged to provide a plurality of local oscillator (LO) signals, respectively. The PLL core circuit is alternately coupled to the plurality of signal paths in a time-sharing manner. The mixers are arranged to receive the first signal, and generate and output the plurality of second signals according to the plurality of LO signals, respectively.

According to a third aspect of the present invention, an exemplary sub-circuit of a reconfigurable wireless receiver is disclosed. The sub-circuit of the reconfigurable wireless receiver includes a down-conversion circuit. The down-conversion circuit is arranged to apply down-conversion to a first signal, and generate and output a plurality of second signals each derived from down-converting the first signal. The down-conversion circuit includes a plurality of oscillators and a plurality of mixers. The oscillators are arranged to provide a plurality of local oscillator (LO) signals, wherein the oscillators include a first oscillator and a second oscillator, and the first oscillator and the second oscillator have different oscillator architecture. The mixers are arranged to receive the first signal, and generate and output the plurality of second signals according to the plurality of LO signals, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless receiver according to an embodiment of the present invention.

FIG. 2 is a diagram illustrating a mode switching operation of the wireless receiver shown in FIG. 1 according to an embodiment of the present invention.

FIG. 3 is a diagram illustrating configurations of an LO signal and a filter under according to an embodiment of the present invention.

FIG. 4 is a diagram illustrating configurations of one LO signal and one filter under the third mode Mode3 according to an embodiment of the present invention.

FIG. 5 is a diagram illustrating configurations of another LO signal and another filter under the third mode Mode3 according to an embodiment of the present invention.

FIG. 6 is a diagram illustrating an LO signal generation circuit according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

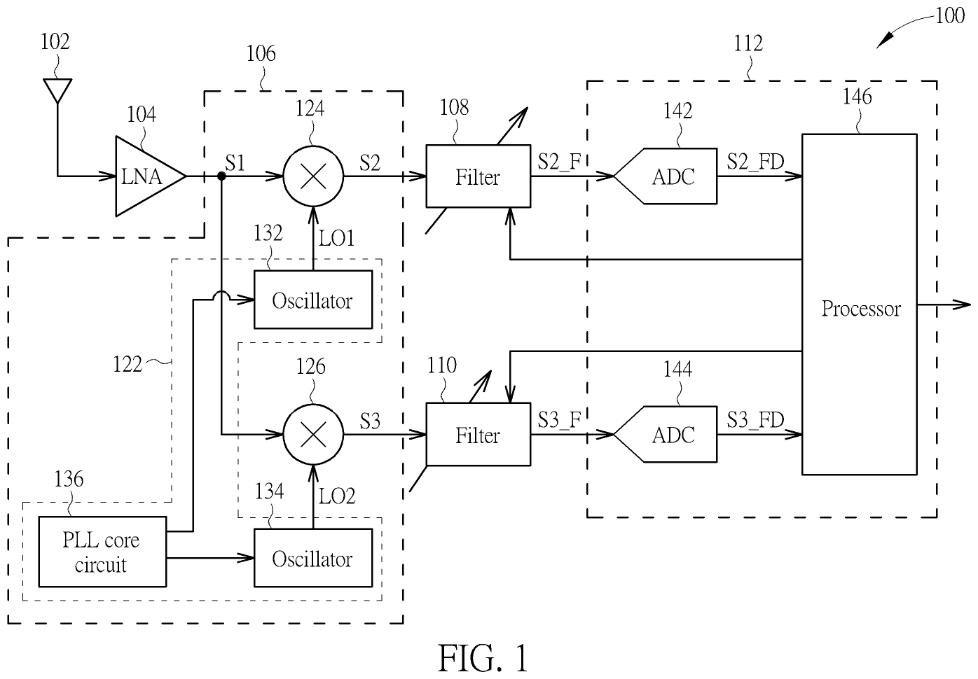

FIG. 1 is a diagram illustrating a wireless receiver according to an embodiment of the present invention. By way of example, but not limitation, the wireless receiver 100 may be a global navigation satellite system (GNSS) receiver that support satellite signal reception of a Beidou system, a global positioning system (GPS), a Galileo system, and a GLONASS system. The wireless receiver 100 may include an antenna 102, a low-noise amplifier (LNA) 104, a down-conversion circuit 106, a plurality of filters 108 and 110, and a processing circuit 112. Regarding the down-conversion circuit 106, it may include a local oscillator (LO) signal generation circuit 122 and a plurality of mixers 124 and 126. In this embodiment, the LO signal generation circuit 122 may include a phase-locked loop (PLL) core circuit 136 and a plurality of oscillators 132 and 134. Regarding the processing circuit 112, it may include a plurality of analog-to-digital converters (ADCs) 142 and 144 and a processor 146.

The down-conversion circuit 106 is arranged to apply down-conversion to an RF signal S1 (which is obtained by passing an RF signal received by the antenna 102 through the LNA 104), and generate and output a plurality of down-converted signals S2 and S3, each derived from down-converting the RF signal S1. The oscillators 132 and 134 are arranged to provide a plurality of LO signals LO1 and LO2 to the mixers 124 and 126, respectively. In this embodiment, the oscillators 132 and 134 may have different oscillator architecture. For example, the oscillator 132 may be a voltage-controlled oscillator (VCO) implemented by an inductor-capacitor (LC) oscillator, and the oscillator 134 may be a ring oscillator implemented by inverters. Since structures and principles of the LC oscillator and the ring oscillator are known to those skilled in the pertinent art, further description is omitted here for brevity.

The mixers 124 and 126 are arranged to receive the RF signal S1, and generate and output the down-converted signals S2 and S3 according to the LO signals LO1 and LO2, respectively. For example, each of the down-converted signals S2 and S3 may be an IF signal or a baseband signal. The filters 108 and 110 are coupled between the down-conversion circuit 106 and the processing circuit 112, and arranged to apply filtering to the down-converted signals S2 and S3 for generating a plurality of filter outputs S2_F and S3_F, respectively. In this embodiment, the filters 108 and 110 may have different filter architecture. For example, the filter 108 may be a resistor-capacitor (RC) filter (e.g. an active filter composed of an operational amplifier along with resistors and capacitors), and the filter 110 may be a transconductance-capacitor (GmC) filter. Compared to the RC filter, the GmC filter has lower current consumption and poorer filter characteristics. Hence, the GmC filter can be used for a low power mode, and the RC filter can be used for a high performance mode. In this embodiment, the wireless receiver 100 is reconfigurable, and can adaptively enable one or both of the filters 108 and 110 for different scenarios, thus achieving power saving without sacrificing the receiver performance. Since structures and principles of the RC filter and the GmC filter are known to those skilled in the pertinent art, further description is omitted here for brevity.

For better comprehension of technical features of the present invention, the following assumes that the filter 108 is an RC filter (i.e. a filter with higher performance and higher power consumption), the filter is a GmC filter (i.e. a filter with lower performance and lower power consumption), the oscillator 132 is an LC oscillator (i.e. an oscillator with higher performance and higher power consumption), and the oscillator 134 is a ring oscillator (i.e. an oscillator with lower performance and lower power consumption). However, these are for illustrative purposes only, and are not meant to be limitations of the present invention.

The processor 146 is a digital circuit. For example, the processor 146 may be a digital baseband processor. When the filter output S2_F is generated from the filter 108, the filter output S2_F is converted from an analog domain to a digital domain by the ADC 142, such that a digital input S2_FD is fed into the processor 146 for further processing. Similarly, when the filter output S3_F is generated from the filter 110, the filter output S3_F is converted from an analog domain to a digital domain by the ADC 144, such that a digital input S3_FD is fed into the processor 146 for further processing. In addition to obtaining the transmitted data from the digital input S2_FD/S3_FD, the processor 146 may perform signal-to-noise ratio (SNR) evaluation and/or jamming detection according to the digital input S2_FD/S3_FD, to control mode switching of the wireless receiver 100. Specifically, the wireless receiver 100 may support a plurality of modes, and may enter different modes for different scenarios. That is, the wireless receiver 100 is reconfigurable, such that the hardware configuration of the wireless receiver 100 can be adaptively adjusted to meet requirements of different scenarios. In this way, the reconfigurable wireless receiver 100 can achieve low power consumption without sacrificing the receiver performance.

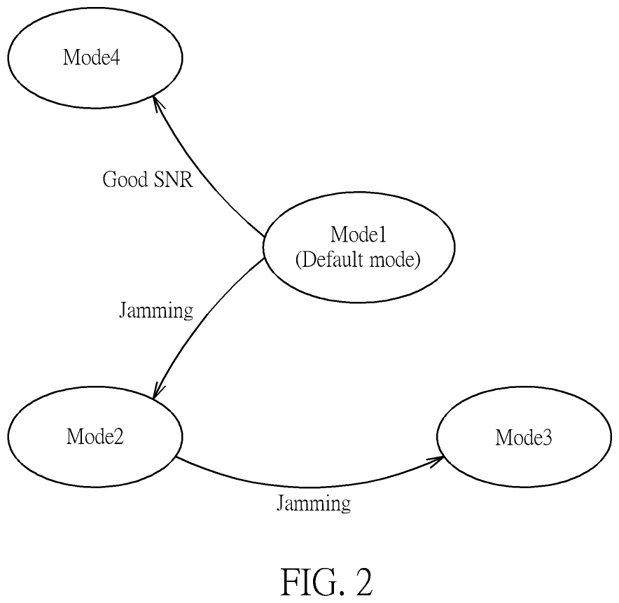

Please refer to FIG. 1 in conjunction with FIG. 2. FIG. 2 is a diagram illustrating a mode switching operation of the wireless receiver 100 according to an embodiment of the present invention. Initially, the wireless receiver 100 enters a first mode Mode1 (which is a default mode). The default mode can be a predetermined mode such as a low power mode. Hence, when the wireless receiver 100 operates under the first mode Mode1, the mixer 124, the oscillator 132, the filter 108, and the ADC 142 may be disabled for power saving, and the LNA 104, the PLL core circuit 136, the oscillator 134, the mixer 126, the filter 110, the ADC 144, and the processor 146 may be enabled for receiving the transmitted data. In a case where the wireless receiver 100 is a GNSS receiver, a bandwidth of the filter 110 is configured to meet a requirement of receiving a plurality of different GNSS bands through the same filter 110. For example, the different GNSS bands may include a Beidou band, a GPS/Galileo band, and a GLONASS band. FIG. 3 is a diagram illustrating configurations of an LO signal and a filter according to an embodiment of the present invention. With proper settings of the LO signal LO2 and the bandwidth of the filter 110 under the first mode Mode1 (i.e. low power mode), signals transmitted via the Beidou band, the GPS/Galileo band, and the GLONASS band can be reserved in the filter output S3_F without being filtered out (attenuated).

When the wireless receiver 100 operates under the first mode Mode1, the processing circuit 112 processes the filter output S3_F of the filter 110 to evaluate an SNR, and detects if the SNR reaches a predetermined threshold. When the SNR is equal to or above the predetermined threshold under the first mode Mode1, the processing circuit 112 (particularly, processor 146 of processing circuit 112) judges that the SNR is good, and instructs the wireless receiver 100 to leave the first mode Mode1 and enter a fourth mode Mode4, as illustrated in FIG. 2. The fourth mode Mode4 may be regarded as an advanced low-power mode. Compared to the wireless receiver 100 operating under the first mode Mode1, the wireless receiver 100 operating under the fourth mode Mode4 can have lower power consumption.

In one exemplary design, when the wireless receiver 100 operates under the fourth mode Mode4, the mixer 124, the oscillator 132, the filters 108 and 110, and the ADC 142 may be disabled for power saving; the LNA 104, the PLL core circuit 136, the oscillator 134, the mixer 126, the ADC 144, and the processor 146 may be enabled for receiving the transmitted data; and the down-converted signal S3 arriving at the filter 110 is bypassed to the processing circuit 112 (particularly, ADC 144 of processing circuit 112) via a bypass path (not shown). Since the filter 110 is disabled, more power can be saved under the fourth mode Mode4.

In another exemplary design, when the wireless receiver 100 operates under the fourth mode Mode4, the mixer 124, the oscillator 132, the filter 108, and the ADC 142 may be disabled for power saving; the LNA 104, the PLL core circuit 136, the oscillator 134, the mixer 126, the filter 110, the ADC 144, and the processor 146 may be enabled for receiving the transmitted data; and a current consumed by the filter 110 is intentionally reduced for additional power saving.

When the wireless receiver 100 operates under the first mode Mode1, the processing circuit 112 further processes the filter output S3_F of the filter 110 to detect if jamming (interfering signal) exists. When jamming is detected under the first mode Mode1, the processing circuit 112 (particularly, processor 146 of processing circuit 112) judges that the filter 110 with a wide bandwidth fails to provide the needed interference rejection. Hence, the processor 146 instructs the wireless receiver 100 to leave the first mode Mode1 and enter a second mode Mode2, as illustrated in FIG. 2. The second mode Mode2 may be regarded as a high performance mode. Compared to the wireless receiver 100 operating under the first mode Mode1, the wireless receiver 100 operating under the second mode Mode2 can have better interference rejection performance.

When the wireless receiver 100 operates under the second mode Mode2, the LNA 104, the PLL core circuit 136, the mixer 124, the oscillator 132, the filter 108, the ADC 142, and the processor 146 may be enabled for receiving the transmitted data, and the oscillator 134, the mixer 126, the filter 110, and the ADC 144 may be disabled for power saving. In a case where the wireless receiver 100 is a GNSS receiver, a bandwidth of the filter 108 is configured to meet a requirement of receiving a plurality of different GNSS bands through the same filter 108. For example, with proper settings of the LO signal LO1 and the bandwidth of the filter 108 as illustrated in FIG. 3, signals transmitted via the Beidou band, the GPS/Galileo band, and then GLONASS band can be reserved in the filter output S2_F without being filtered out (attenuated). Since the filter 108 has better filter characteristics, a strong out-of-band interference may be filtered out (attenuated) after a receiver mode is switched from the first mode Mode1 to the second mode Mode2.

When the wireless receiver 100 operates under the second mode Mode2, the processing circuit 112 processes the filter output S2_F of the filter 108 to detect if jamming (interfering signal) still exists. When jamming is detected under the second mode Mode2, the processing circuit 112 (particularly, processor 146 of processing circuit 112) judges that the filter 108 with a wide bandwidth fails to provide the needed interference rejection. Hence, the processor 146 instructs the wireless receiver 100 to leave the second mode Mode2 and enter a third mode Mode3, as illustrated in FIG. 2. The third mode Mode3 may be regarded as an advanced high-performance mode. Compared to the wireless receiver 100 operating under the second mode Mode2, the wireless receiver 100 operating under the third mode Mode3 can have better interference rejection performance.

When the wireless receiver 100 operates under the third mode Mode3, all of the LNA 104, the PLL core circuit 136, the mixers 124 and 126, the oscillators 132 and 134, the filters 108 and 110, the ADCs 142 and 144, and the processor 146 may be enabled. In other words, two receive (RX) paths are both enabled under the third mode Mode3, and the processor 146 processes both of the digital signals S2_FD and S3_FD to obtain transmitted data of different frequency bands. In a case where the wireless receiver 100 is a GNSS receiver, a bandwidth of the filter 108 is configured to meet a requirement of receiving only a first part of different GNSS bands through the same filter 108, and a bandwidth of the filter 110 is configured to meet a requirement of receiving only a second part of the different GNSS bands through the same filter 110. Compared to the filter 108 under the second mode Mode2, the filter 108 under the third mode Mode3 has a narrower bandwidth, thus leading to better interference rejection performance as well as lower current consumption. Similarly, compared to the filter 110 under the first mode Mode1, the filter 110 under the third mode Mode3 has a narrower bandwidth, thus leading to better interference rejection performance as well as lower current consumption.

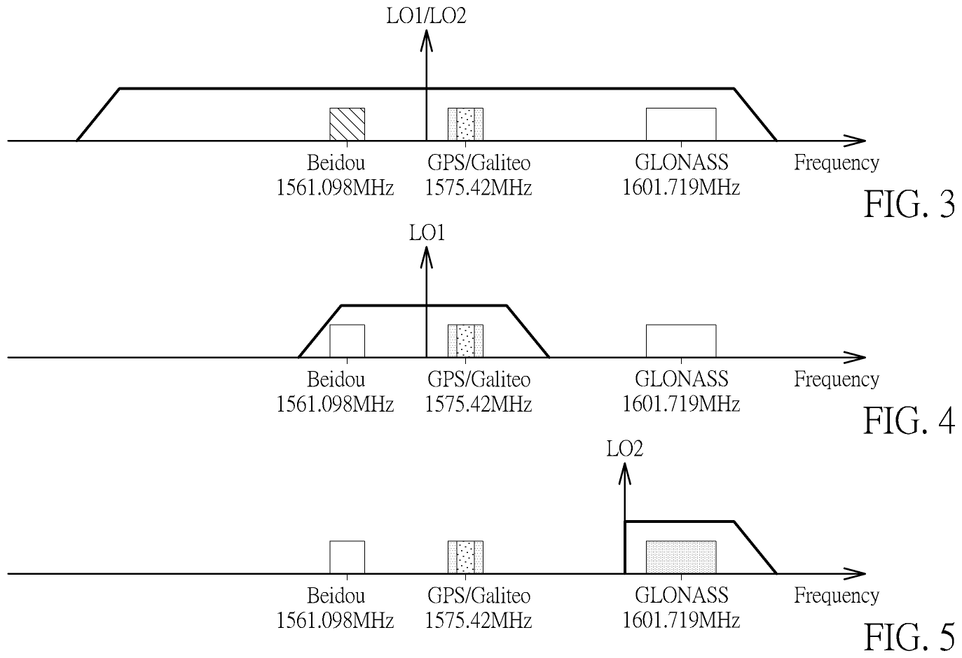

Please refer to FIG. 4 in conjunction with FIG. 5. FIG. 4 is a diagram illustrating configurations of one LO signal and one filter under the third mode Mode3 according to an embodiment of the present invention. FIG. 5 is a diagram illustrating configurations of another LO signal and another filter under the third mode Mode3 according to an embodiment of the present invention. With proper settings of the LO signal LO1 and the bandwidth of the filter 108, signals transmitted via the Beidou band and the GPS/Galileo band can be reserved in the filter output S2_F without being filtered out (attenuated). Similarly, with proper settings of the LO signal LO2 and the bandwidth of the filter 110, signals transmitted via the GLONASS band can be reserved in the filter output S3_F without being filtered out (attenuated). It should be noted that configurations of LO signals and filters shown in FIG. 4 and FIG. 5 are for illustrative purposes only, and are not meant to be limitations of the present invention. In one alternative design, the LO signal LO1 and the bandwidth of the filter 108 may be configured for receiving signals of a single GNSS band, and the LO signal LO2 and the bandwidth of the filter 110 may be configured for receiving signals of multiple GNSS bands.

To achieve more power reduction, the wireless receiver 100 may be designed to use oscillators 132 and 134 with different oscillator architecture. In some embodiments of the present invention, the oscillator 132 used for generating the LO signal LO1 to the mixer 124 (which is used for generating and outputting the down-converted signal S2 to the filter 108) may be an LC oscillator, and the oscillator 134 used for generating the LO signal LO2 to the mixer 126 (which is used for generating and outputting the down-converted signal S3 to the filter 110) may be a ring oscillator. Compared to the LC oscillator with an LC tank, the ring oscillator implemented by inverters has lower power consumption. Compared to the ring oscillator implemented by inverters, the LC oscillator with an LC tank has better oscillator characteristics. The LC oscillator is suitable for the high performance mode, while the ring oscillator is suitable for the low power mode. For example, when the wireless receiver 100 operates under the first mode Mode1 (i.e. low power mode), the oscillator 134 with lower power consumption is enabled, and the oscillator 132 with higher power consumption is disabled. For another example, when the wireless receiver 100 operates under the second mode Mode1 (i.e. high performance mode), the oscillator 132 with a high-accuracy LO output is enabled, and the oscillator 134 with a low-accuracy LO output is disabled.

To achieve more power reduction, the wireless receiver 100 may be designed to use a time-sharing PLL core for locking output frequencies of two oscillators 132 and 134 alternately. For example, when the wireless receiver 100 operates under the third mode Mode3, the PLL core circuit 136 is used to control the LO frequency of one of the LO signals LO1 and LO2, and is reused to control the LO frequency of the other of the LO signals LO1 and LO2. Compared to using two individual PLL circuits for setting the LO signals LO1 and LO2, using a single PLL core circuit for setting the LO signals LO1 and LO2 in a time-sharing manner can have lower power consumption as well as lower hardware cost.

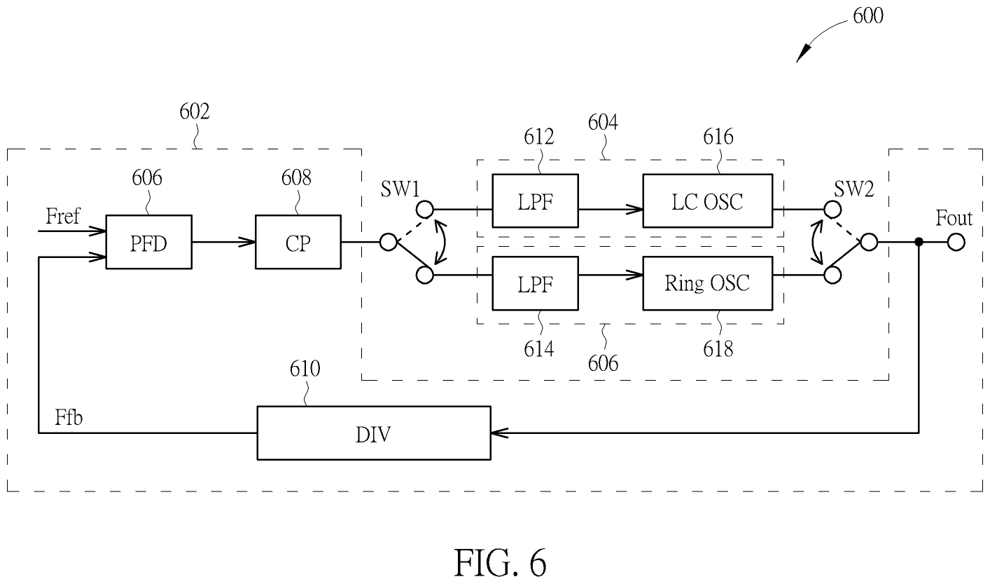

FIG. 6 is a diagram illustrating an LO signal generation circuit according to an embodiment of the present invention. The LO signal generation circuit 600 employs the proposed time-sharing PLL architecture, and may include a PLL core circuit 602 and a plurality of signal paths 604 and 606. The connections between the PLL core circuit 602 and the signal paths 604 and 606 may be controlled by switches SW1 and SW2. The same PLL core circuit 602 can be shared by two signal paths 604 and 606, and may include a phase frequency detector (PFD) 606, a charge pump (CP) 608, and a frequency divider (labeled by “DIV”) 610. One low-pass filter (LPF) 612 and one LC oscillator (labeled by “LC OSC”) 616 are located at one signal path 604. One LPF 614 and one ring oscillator (labeled by “Ring OSC”) 618 are located at the other signal path 606. The output frequency Fout is divided by the frequency divider 610, and a feedback frequency Ffb is provided to the PFD 606. The adjustment of the output frequency Fout is controlled by the PLL core circuit 602 in response to discrepancy between a reference clock with the reference frequency Fref and a feedback signal with the feedback frequency Ffb.

The LO signal generation circuit 122 shown in FIG. 1 may be implemented by the LO signal generation circuit 600 shown in FIG. 6. Specifically, the PLL core circuit 136 may be implemented by the PLL core circuit 602, the oscillator 132 may be implemented by the LC oscillator 616, and the oscillator 134 may be implemented by the ring oscillator 618. When the wireless receiver 100 operates under the first mode Mode1, the PLL core circuit 602 can be coupled to the signal path 606 through switches SW1 and SW2. When the wireless receiver 100 operates under the second mode Mode2, the PLL core circuit 602 can be coupled to the signal path 604 through switches SW1 and SW2. When the wireless receiver 100 operates under the third mode Mode3, the PLL core circuit 602 can be alternately coupled to the signal paths 604 and 606 in a time-sharing manner. For example, when the wireless receiver 100 operates under the third mode Mode3, each of the switches SW1 and SW2 enables an upper branch for allowing an output of the CP 608 to be fed into the LPF 612 and an output of the LC oscillator 616 to be fed into the frequency divider 610 during one of non-overlapping periods, and each of the switches SW1 and SW2 enables a lower branch for allowing an output of the CP 608 to be fed into the LPF 614 and an output of the ring oscillator 618 to be fed into the frequency divider 610 during another of non-overlapping periods. Since the LO signals LO1 and LO2 may have different LO frequencies under the third mode Mode3, the reference frequency Fref may be switched between different values, and/or a frequency division factor of the frequency divider 610 may be switched between different values.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sub-circuit of a reconfigurable wireless receiver comprising:
a down-conversion circuit, arranged to apply down-conversion to a first signal, and generate and output a plurality of second signals each derived from down-converting the first signal; and
a plurality of filters, coupled to the down-conversion circuit, and arranged to apply filtering to the plurality of second signals for generating a plurality of filter outputs, respectively, wherein the plurality of filters comprise a first filter and a second filter, and the first filter and the second filter have different filter architecture.

2. The sub-circuit of claim 1, wherein the first filter is a resistor-capacitor (RC) filter, and the second filter is a transconductance-capacitor (GmC) filter.

3. The sub-circuit of claim 2, wherein the reconfigurable wireless receiver is a global navigation satellite system (GNSS) receiver.

4. The sub-circuit of claim 3, wherein in response to the reconfigurable wireless receiver operating under a first mode, the RC filter is disabled, the GmC filter is enabled, and a bandwidth of the GmC filter is configured to meet a requirement of receiving a plurality of different GNSS bands through the GmC filter.

5. The sub-circuit of claim 4, further comprising:
a processing circuit, arranged to process a filter output of the GmC filter to evaluate a signal-to-noise ratio (SNR) under the first mode, and detect if the SNR reaches a predetermined threshold;
wherein in response to the SNR reaching the predetermined threshold under the first mode, the reconfigurable wireless receiver enters a second mode for disabling the GmC filter and bypassing one of the second signals that arrives at the GmC filter.

6. The sub-circuit of claim 4, further comprising:
a processing circuit, arranged to process a filter output of the GmC filter to evaluate a signal-to-noise ratio (SNR) under the first mode, and detect if the SNR reaches a predetermined threshold;
wherein in response to the SNR reaching the predetermined threshold under the default mode, the reconfigurable wireless receiver enters a second mode for reducing a current consumed by the GmC filter.

7. The sub-circuit of claim 4, further comprising:
a processing circuit, arranged to process a filter output of the GmC filter to detect if jamming exists under the first mode;
wherein in response to determining that jamming exists under the first mode, the reconfigurable wireless receiver enters a second mode for disabling the GmC filter, enabling the RC filter, and configuring a bandwidth of the RC filter to meet a requirement of receiving the plurality of different GNSS bands through the RC filter.

8. The sub-circuit of claim 7, wherein the processing circuit is further arranged to process a filter output of the RC filter to detect if jamming exists under the second mode;
wherein in response to determining that jamming exists under the second mode, the reconfigurable wireless receiver enters a third mode for enabling both of the RC filter and the GmC filter, configuring a bandwidth of the RC filter to meet a requirement of receiving only a first part of the plurality of different GNSS bands through the RC filter, and configuring a bandwidth of the GmC filter to meet a requirement of receiving only a second part of the plurality of different GNSS bands through the GmC filter.

9. The sub-circuit of claim 1, wherein the down-conversion circuit comprises:
a plurality of oscillators, arranged to provide a plurality of local oscillator (LO) signals, wherein the plurality of oscillators comprise a first oscillator and a second oscillator, and the first oscillator and the second oscillator have different oscillator architecture; and
a plurality of mixers, arranged to receive the first signal, and generate and output the plurality of second signals according to the plurality of LO signals, respectively.

10. The sub-circuit of claim 9, wherein the first oscillator is an inductor-capacitor (LC) oscillator, and the second oscillator is a ring oscillator.

11. The sub-circuit of claim 10, wherein the plurality of mixers comprise:
a first mixer, arranged to receive the first signal and an LO signal generated from the LC oscillator, and generate and output one of the plurality of second signals to the first filter; and
a second mixer, arranged to receive the first signal and an LO signal generated from the ring oscillator, and generate and output another of the plurality of second signals to the second filter;
wherein the first filter is a resistor-capacitor (RC) filter, and the second filter is a transconductance-capacitor (GmC) filter.

12. The sub-circuit of claim 9, further comprising:
an LO signal generation circuit, comprising:
a plurality of signal paths, wherein the plurality of oscillators are located at the plurality of signal paths, respectively; and
a phase-locked loop (PLL) core circuit, alternately coupled to the plurality of signal paths in a time-sharing manner.

13. A sub-circuit of a reconfigurable wireless receiver comprising:
a down-conversion circuit, arranged to apply down-conversion to a first signal, and generate and output a plurality of second signals each derived from down-converting the first signal, wherein the down-conversion circuit comprises:
a local oscillator (LO) signal generation circuit, comprising:
a plurality of signal paths, wherein a plurality of oscillators are located at the plurality of signal paths, respectively, and the plurality of oscillators are arranged to provide a plurality of LO signals, respectively;
a phase-locked loop (PLL) core circuit, alternately coupled to the plurality of signal paths in a time-sharing manner; and
a plurality of mixers, arranged to receive the first signal, and generate and output the plurality of second signals according to the plurality of LO signals, respectively.

14. The sub-circuit of claim 13, wherein the plurality of oscillators comprise a first oscillator and a second oscillator, and the first oscillator and the second oscillator have different oscillator architecture.

15. The sub-circuit of claim 14, wherein the first oscillator is an inductor-capacitor (LC) oscillator, and the second oscillator is a ring oscillator.

16. The sub-circuit of claim 14, wherein the reconfigurable wireless receiver is a global navigation satellite system (GNSS) receiver.

17. A sub-circuit of a reconfigurable wireless receiver comprising:
a down-conversion circuit, arranged to apply down-conversion to a first signal, and generate and output a plurality of second signals each derived from down-converting the first signal, wherein the down-conversion circuit comprises:
a plurality of oscillators, arranged to provide a plurality of local oscillator (LO) signals, wherein the plurality of oscillators comprise a first oscillator and a second oscillator, and the first oscillator and the second oscillator have different oscillator architecture; and
a plurality of mixers, arranged to receive the first signal, and generate and output the plurality of second signals according to the plurality of LO signals, respectively.

18. The sub-circuit of claim 17, wherein the first oscillator is an inductor-capacitor (LC) oscillator, and the second oscillator is a ring oscillator.

19. The sub-circuit of claim 17, wherein the reconfigurable wireless receiver is a global navigation satellite system (GNSS) receiver.
